(19) United States
(12) Patent Application Publication
(10) Pub. No.: US 2015/0006424 A1
(43) Pub. Date: Jan. 1, 2015

(54) College admission optimizer for an individualized education consulting system and method

(71) Applicant: ThinkTank Learning Inc., Santa Clara, CA (US)

(72) Inventors: Steven Ma, San Jose, CA (US); Stanley Chung Shun Wei, Fremont, CA (US)

(73) Assignee: ThinkTank Learning Inc.

(21) Appl. No.: 14/334,103

(22) Filed: Jul. 17, 2014

Related U.S. Application Data
(63) Continuation-in-part of application No. 13/931,232, filed on Jun. 28, 2013.

(51) Int. Cl. G06Q 50/20; G06F 17/18

(52) U.S. Cl. CPC G06Q 50/2053; G06F 17/18
USPC 705/327

(57) ABSTRACT

A method and system automate data maintenance, transformation, and utilization for an individualized education consulting business. The system is designed to build a customized service plan for each student's unique needs. A College Admission Optimizer is a logistic regression model, based on the admission history of college applications, and a student's personality, individual interests, and current academic performance, and it calculates the chances of admission for each selected school, and provides a strategic opinion. The system and method quantify admission criteria and optimizes student's chance of getting into colleges.

### RELATED APPLICATION

This application is a continuation-in-part of and claims the benefit of a co-pending U.S. application Ser. No. 13,931,232, filed on Jun. 28, 2013, the specifications of which is included its entirety by this reference.

### FIELD OF THE INVENTION

The present invention generally relates computerized educational consulting system, and more specifically relates to a computer-based-system that devises educational strategic planning based on statistical analysis.

### BACKGROUND OF THE INVENTION

Education does not begin and end with test preparation classes, tutoring or college applications. It is the culmination of years of academic and personal development. College admission is a nebulous process; too many students and parents think the outcome is completely ‘random’, however it has been observed that the outcome is predictable and optimizable. An educational consulting can offer individualized academic counseling, extracurricular activity and internship development, one-on-one tutoring, and premium college application consultation; and a ‘College Admission Optimizer’ optimizing student's chance of getting into colleges, which simplifies the college admission process into exact science.

Within this educational consulting business, different tasks are performed by different people. For instance, the education consultants (or consultants) need to keep track of each student's data, which includes GPA, SAT or ACT, school courses taken, plan for Extracurricular Activities (EA), internships, conduct intakes (interviews) to prepare strategic positioning report, decide tutoring needs, monitor classes' progress, analyze admission chances, make school selections, and check on school application status. The tutors need to keep track of his/her student list, curriculum, progress, and teaching hours. A site manager needs to manage classrooms, finance, and prepares for call log reports, marketing and sales reports and each client's contract management. Human resource personnel support entire company's recruiting, training, and award determination. Sales and marketing personnel are responsible for new product development, study client's address to determine the location of the next new center and advertisement. System engineers are implementing the data centralization and permission control, score data representation based on different formulas, and maintaining all the system requirements from every role and department within the company.

There are conventional tools that can help education consultants/counselors to check on students scores (SAT, GPA, Honors, Extracurricular Activities, etc.) and perform school selections for their students. However, these tools do not support individualized academic counseling, such as conducting personal intakes (interviews), generating a strategic positioning report for a particular student for his/her school application essays, and provide a statistical analysis in order to strengthen the student's weakness and increase the chances to be accepted by colleges. Those conventional tools will not perform extracurricular activities analysis based on a student's unique interest; they do not provide analysis for chances of admissions, and they do not do a diagnostic based on the student's current information so the student knows which areas to improve upon. A method or system with effective data analysis and management functions is hence needed in such a business, which facilitates the communication between the consultants, tutors, managers, parents, system engineers, and students; and ensures data sharing, updating, and delivering effectively.

### SUMMARY OF THE INVENTION

The present invention has been made to overcome the aforementioned disadvantages of conventional methods. The primary object of the present invention is to provide an automated individualized academic counseling system. The educational counseling system is a data management system, which is designed to ‘customer build’ for each of the client's unique needs. Based on student's personality, academic performance, and individualized requirements, the educational counseling system automatically generates an extracurricular activity (EA) plan, provides advice for internship development, one-on-one tutoring, personalized diagnostic, admission chances optimization, and premium college application consultation. In fact, with appropriate modifications the invention can be further used for private high school applications as well.

In general, the college application selection evaluates three main areas: (1) Student's Academics; including GPA, Honor/AP classes, A-G courses; they are: A: History/Social Science; B: English; C: Mathematics; D: Laboratory science; E: Language other than English; F: Visual and Performing Arts; and G: College-preparatory elective; (2) Standardized Tests; which including SAT or ACT, SAT subject test(s), AP, and TOEFL or IELTS for international applicants; and (3) Extracurricular Activities (EA), which including Clubs, Sports, Leaderships, Talents, Volunteer works, internships, awards etc.

The first area, the student's academic data, which includes classes he/she has taken since grade 7 to grade 12, grades he/she has obtained, honor type, they are entered and able to be viewed under ‘Academic’ option, see FIGS. 3A and 3B.

The second area, the student's standardized test scores, are also entered by the consultant and stored in the education counseling system, which can be viewed under ‘Tests’ option, see FIG. 4.

And the third area, the student's EAs, they are categorized as ‘Club’, ‘Sports’, ‘Talents’, ‘Leadership’, ‘Education Prep’, ‘Volunteer’, ‘Work’, and ‘Signature project’; based on US News annual college rankings, we've divided schools into 5 tiers. Each of the college tiers with a minimum required events; for example, for tier 1 schools (US News™ ranked 1-16 schools), the student needs three club events, two sports, three talent events, two leadership events, minimum 450 volunteer hours, two work events, and two Signature projects. The system quantifies the EAs into scores, and EA scores are automatically calculated by a formula that is further described in later section, see Table 2 below.

All three areas are diagnosed under the ‘Diagnostic’ function as shown in FIG. 2A-2C.

When working for the above mentioned areas, parents and students normally don't know how well the student's performance is good enough? Are the student's time and efforts really being contributed to the area that he/she needs to improve?

A College Admission Optimizer that uses logistic regression model, based on students admission records, in A-G courses, GPA, SAT, SAT Subject tests, AP, Extracurricular, Leadership, Trend . . . etc., to predict the students' admission possibilities of the Universities. The College Admission Optimizer is part of the data management system and provides a strategic opinion indicates in which area should the student to improve. For example, see FIG. 6, a student has the following status: SAT score of 2000, GPA of 3.65, SAT II averaged score 655, 51 A-G courses, and 14 Honor/AP courses; based on the optimizer, his current chance to be admitted by UCSD (University of California, San Diego) is 12%. If he only increases his SAT score to 2200, FIG. 7, his chance becomes 14%; if he only increases his leadership to 2, FIG. 8, his chance is 22%; however if he increases his GPA to 4.15, FIG. 9, his chance hits 71%;—this provides a guidance to the student, given the limited amount of time, it will be best to improve his GPA, because higher GPA will bring up his chances of admission the dramatically for all UC schools.

The Admission Optimizer is also able to produce an “admission tree” (Binary Tree) graph, which is based on Classification and Regression Trees (CART) prediction method, which is an alternative to the logistic regression model, see FIG. 10. The “admission tree” shows the break points for admission chances for a school's admission criteria; based on the analysis result, it indicates the admission chances for the UC Berkeley, if a student's GPA>=4.125, and his/her SAT I score is>=2150, and he/she has more than 50 A-G courses taken, his acceptance chance is 97.1% (the right most node of the tree). This tool provides a very clear information about what GPA, SAT I score, A-G courses . . . etc, will bring a student high chances to make in a certain school.

The foregoing and other objects, features, aspects and advantages of the present invention will become better understood from a careful reading of detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 illustrates an overall Data Use Diagram for various users;

FIG. 2A, a window showing the ‘Diagnostic’ result for the designated student, wherein Tier 2 is preselected;

FIG. 2B, a window showing the ‘Diagnostic’ result for the designated student, the Academic, Test, and EA analysis;

FIG. 2C, a flow chart for Diagnostic processing;

FIG. 3A and FIG. 3B, a window showing the ‘Academic’ screen for a student's academic information;

FIG. 4, a window showing the ‘Tests’ screen for a student's standardized test scores;

FIG. 5A and FIG. 5B, a window showing the ‘College List’ screen for selected schools, and their chances for admission;

FIG. 6, a window showing the optimizer originally calculated all UC admission chances for a student with 51 A-G courses, 14 AP/Honor courses, SAT II average score 655, SAT 2000, UC-GPA 3.65, and Leadership (LD) 0; wherein UCB is UC at Berkeley, UCLA is UC at Los Angeles, UCSD is UC at San Diego, UCD is UC at Davis, UCSB is UC at Santa Barbara, UCI is UC at Irvine, UCSC is UC at Santa Cruz, UCR is UC at Riverside, and UCM is UC at Merced;

FIG. 7, a window showing the optimizer automatically calculates the admission chances for the given student in FIG. 6, if other factors stay the same, only SAT score changed from 2000 to 2200;

FIG. 8, a window showing the optimizer automatically calculates the admission chances for the given student in FIG. 6, if other factors don't change only leadership changed from 0 to 2;

FIG. 9, a window showing the optimizer automatically calculates the admission chances for the given student in FIG. 6, if other factors don't change only change UC-GPA from 3.65 to 4.15;

FIG. 10, showing the College Admission Optimizer produces an ‘admission tree’ for UC Berkeley;

FIG. 11 illustrates a hardware architecture diagram for the education counseling system;

FIG. 12 illustrates an exemplary computer system that can be configured to perform the educational consulting processes of FIGS. 1-10.

### DETAILED DESCRIPTION OF THE PREFERRED EMBODIMENTS

The present invention is directed to a computer-implemented method and system that enables an educational consultant to have a very thorough and personal understanding about a student and to provide a tailored guidance to the student according to the personal understanding. The consulting process normally starts with a minimum two-hour intake (interview), which is for an education consultant (or a consultant throughout the application) to meet the student and conduct an interview with the student at the beginning of the consultation, to collect the student's academic, standardized test, extracurricular activities, volunteer work, and other related data. After the intake, the education consulting system will generate a strategic positioning report for the student, which is a summary of the student's strengths, efforts, and endeavors based on his/her past experiences. A school admission chances analysis is also included that is generated by a functional component of the education system, a College Admission Optimizer, which will be described in a later section. The strategic positioning report will be a guideline for the student's school selections (a preselected school tier based on his/her current performance), college essays, as well as a reminder for the education consultant to follow up on certain weakness of the student. The consulting process will be a long-term effort, at times involving parents to collect more information about the student. The strategic positioning report later will lead to a school application brainstorm document for each of the college essay topics. The education consultant also needs to find out what the student's interests and strengths are, and to search for an activity for the student if he/she doesn't have one yet (such as an extracurricular activity). The educational counseling system provides a ‘diagnostic’ function based on a preselected school tier, which will produce an analyzed result for Academics, Standardized Tests, and EAs for the student, so the student knows which area(s) to improve upon in order to achieve the school tier he/she has preselected.

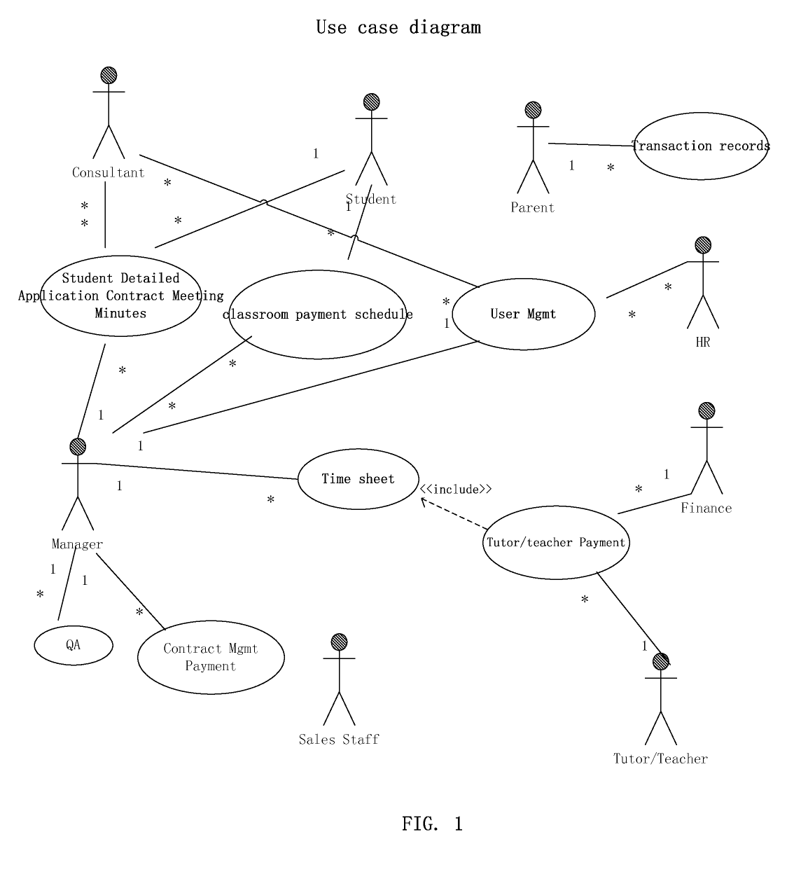

The present invention provides specialized user interfaces for different users of the educational system, via an input device and display device, each interface allows a designated user to enter, retrieve, and modify a special set of data; and after various functions been executed, different reports will be generated automatically. FIG. 1 is a data use diagram; it shows the data can be accessed by different role(s); wherein the line indicates the type of role (user) can use the feature (oval shape). For example, Consultant, Student, and Manger can use/access “Student Detailed Application Contract Meeting Minutes”. It also shows the relationship is 1 to many (1,*), many to many (*, *), or 1 to 1.

The data are entered and modified by different users, and are stored in a shared database, via a network connected with remote centers. The data are managed by a data management system and each user's access to the data is controlled according to user's designated authentication. The education consultant is only authorized to access his/her own students' data. For example, the educational consultant chooses colleges for his/her students and monitors each of the college admission chances and school application status.

A strategic calculation unit is part of the data management system, which will generate a strategic positioning report based on the stored student data, which includes a preselected school tier based on the student's current performance for the student. The school application essay brainstorm document is generated by a document generation unit, which is also part of the data management system. The document generation unit analyzes the stored student data (collected from intakes between an education consultant and his/her students), and generates the school application essay brainstorm document; the school application essay brainstorm is retrievable from the data management system. The school application essay brainstorm document serves as a blueprint for the student's future college application essays. Both the strategic positioning report and the school application essay brainstorm document are stored in and managed by the data management system.

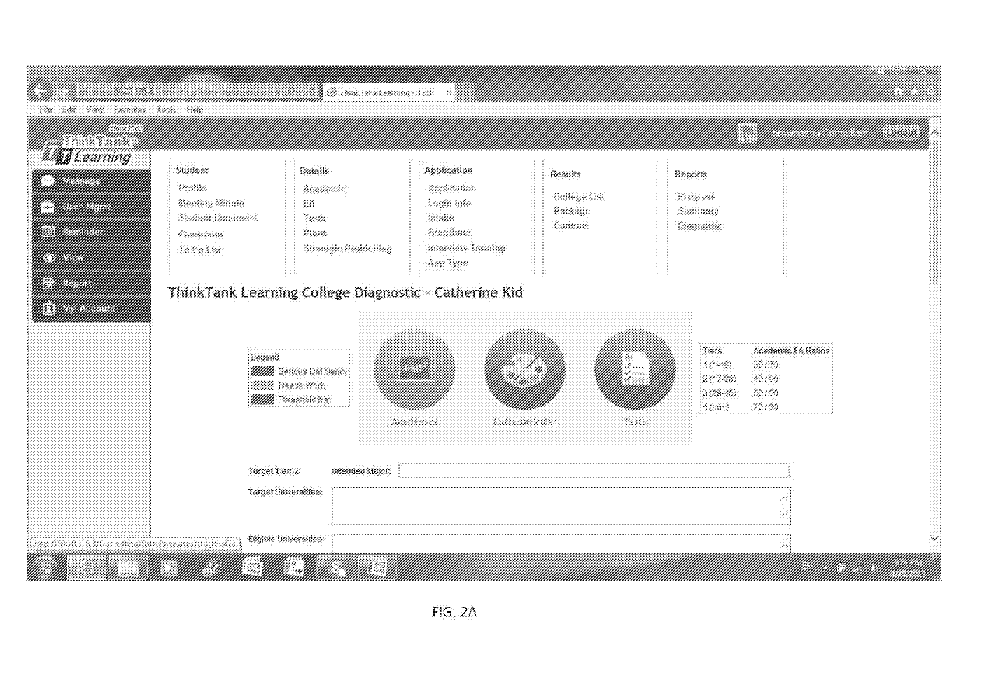

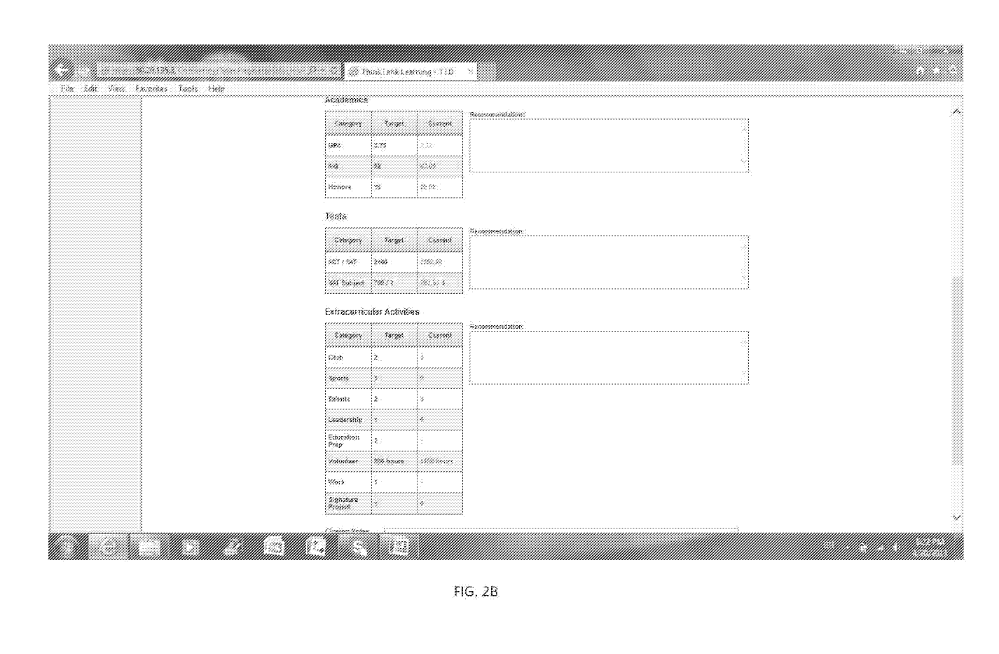

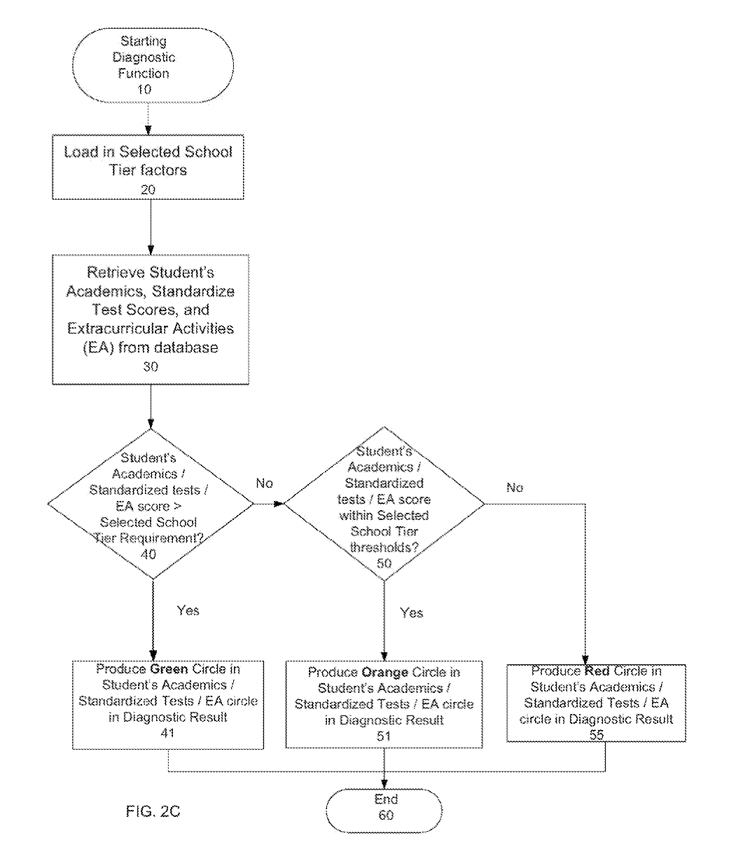

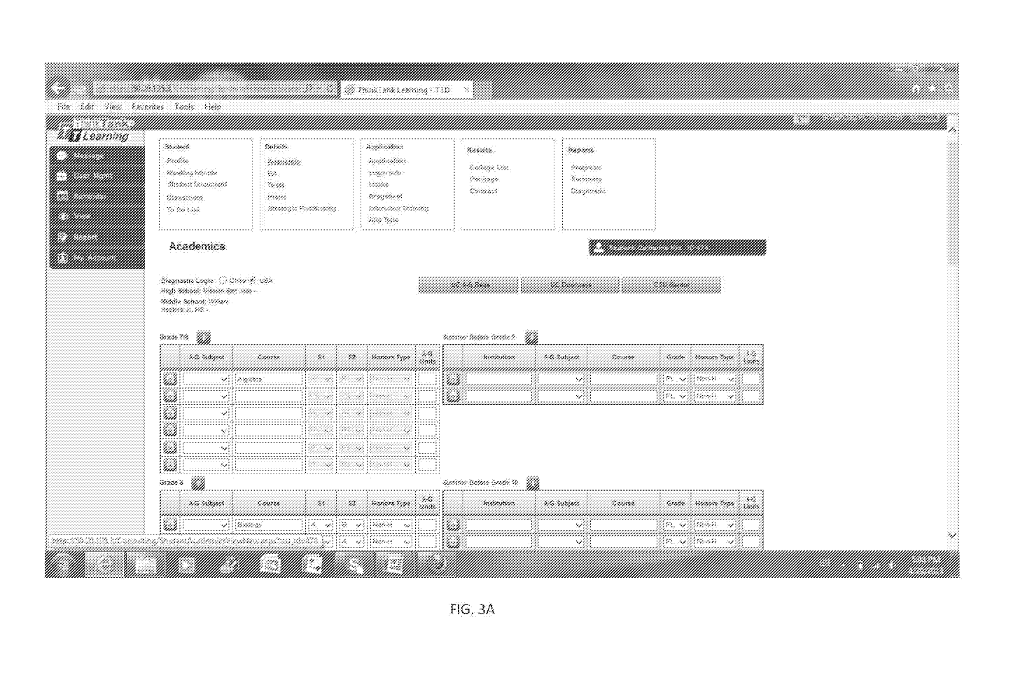

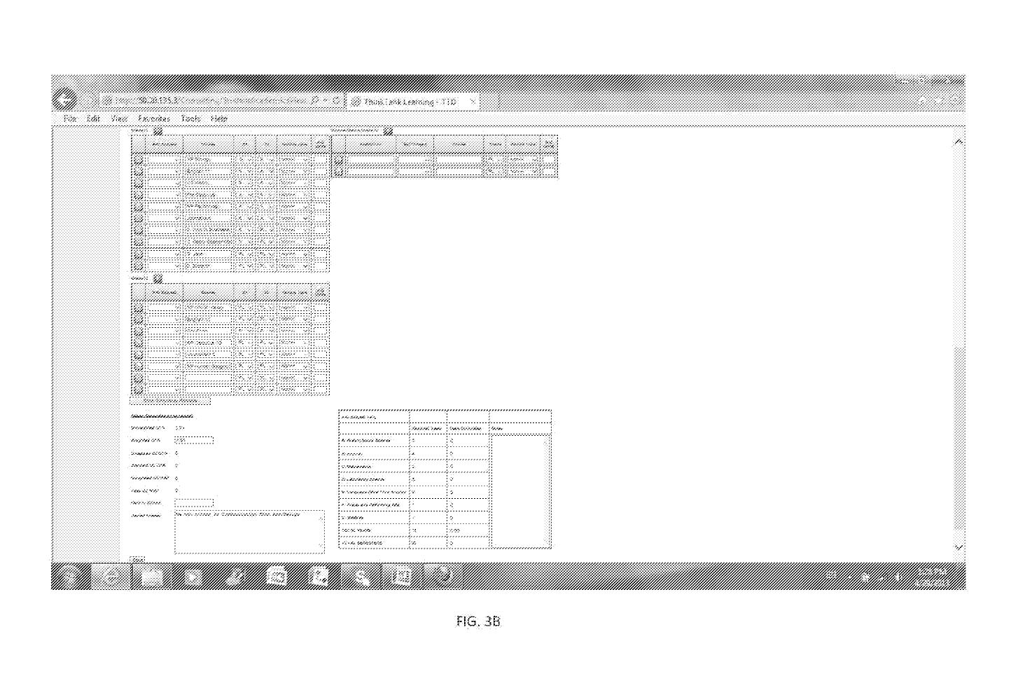

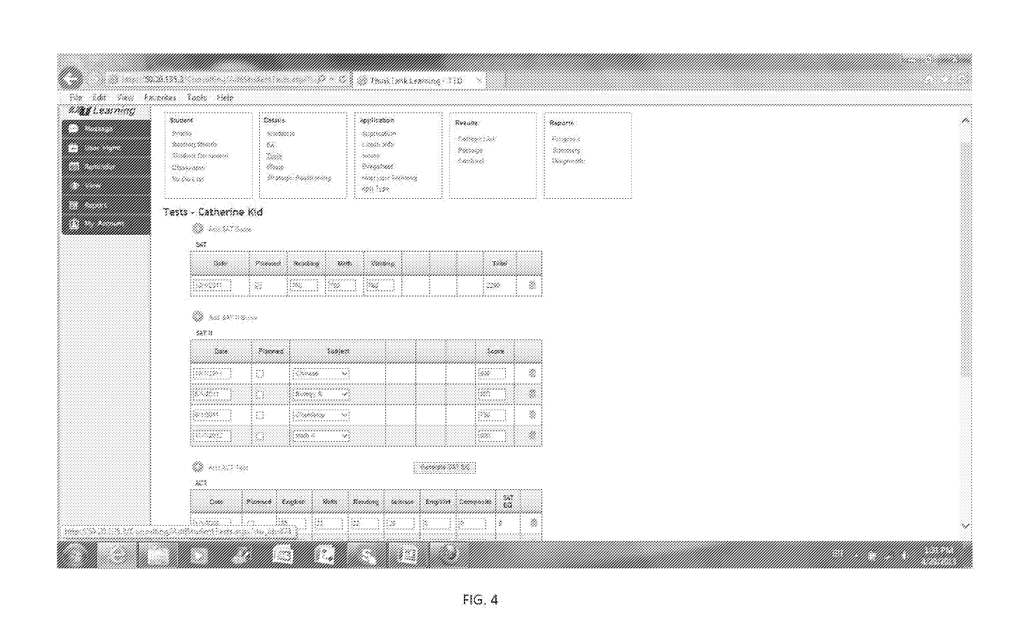

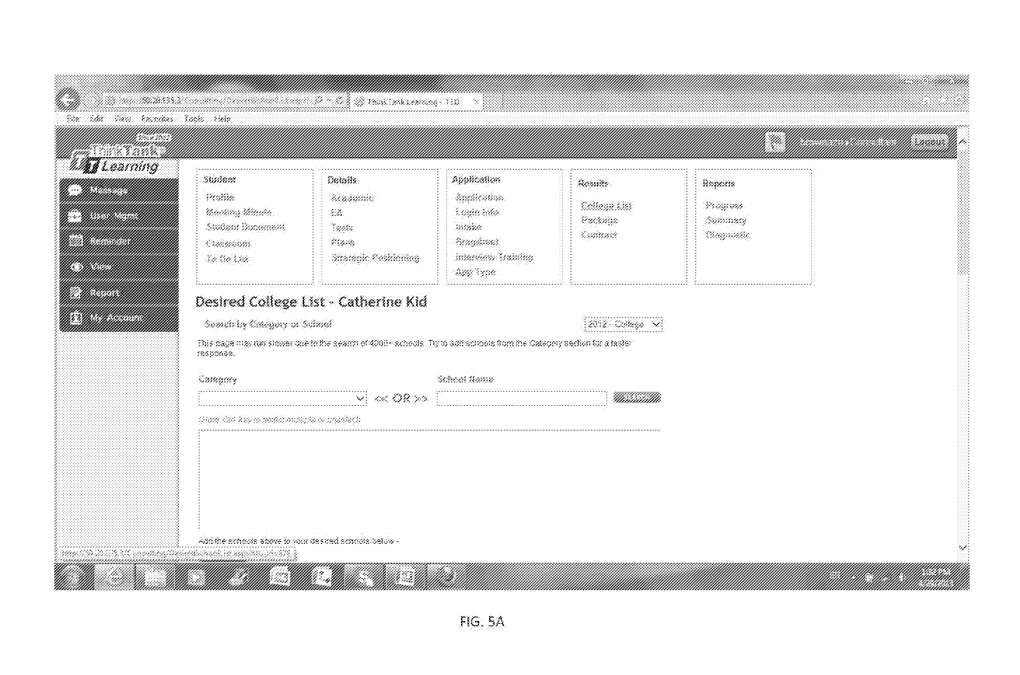

The Diagnostic function of the educational consulting system produces ‘diagnostic’ results (see FIGS. 2A, 2B, 2C); the results are automatically included in the calculation of the strategic positioning report, via the strategic calculation unit, which is a part of the data management system. The ‘diagnostic’ results provide a clear indication about the student's current the Academic, Standard tests, and Extracurricular Activities performances. The Diagnostic function is performed based on the student data for the three areas (Academics, Standardized Tests, and Extracurricular Activities) described above and a preselected school tier. The data management system would automatically generate a diagnostic report based on a special algorithm, and the diagnostic report will indicate what area the student still needs improvement for the preselected school tier, the algorithm is illustrated in FIG. 2C. For example, Catherine is a high school senior in California, in her case, she is projecting tier 2 schools (US News™ ranked number 17-28 schools), which requires GPA to be 3.75 (see Table 2 below), but her GPA is 3.72, which met the threshold, therefore the diagnostic report shows orange color in the Academic circle (green circle means requirement is met, i.e. student's score is greater than the required score; red circle means the student needs a big improvement), see FIG. 2A., FIG. 2B., and FIG. 2C. The education consultant, parents, and the student can reference the preselected school tier and then decide the final selected schools based on the diagnostic report. However, if the student and the parents want to try more challenging schools or reaching schools, they will decide a final selected school list (the education consultant would have to agree on it). And the school application status for each of the final selected schools will be monitored in the data management system.

The Diagnostic function used special factors, the factors are defined for each tier of the schools; such as for tier 1 ranking schools (US News ranked 1-16 schools), the minimum Academic requirements for GPA is 3.85 (unweighted), A-G course units is 56 (one semester of English=1 unit; one year, that is two semesters, of Math=2 units), and Honors/AP class units is 20. The Extracurricular Activities (EAs) constitute another major factor, they are categorized as ‘Club’, ‘Sports’, ‘Talents’, ‘Leadership’, ‘Education Prep’, ‘Volunteer’, ‘work’, and ‘Signature Project’; each of the EAs has a minimum required events. For example, for tier 1 schools, the student needs three club events (such as debate team, student government, and Robot club), two sports, three talent events, two leadership events, minimum 450 volunteer hours, two work events (internship), and two Signature projects. An EA score is calculated automatically by the data management system, for example, each event is assigned by a specific number (coefficient), adding up all the EA event numbers participated by the student and then dividing the result by a total EA item number to get the student's EA score (quantifying the EA events).

EA Score=Sum(EA Coefficient×EA items)/Total EA items

The coefficient for each EA event is listed on Table 1 below:

TABLE 1

| EA Item | EA Coefficient |
|---|---|
| Club | 1 |
| Sports | 1 |
| Talents/Arts | 1 |
| Leadership | 3 |
| Prep Education | 2 |
| Volunteer | 2 |
| Work/Internship | 1 |
| Signature program | 2 |

If the student's EA score is greater than a targeted school score, a green circle is displayed on the EA report; if the EA score is less or equal to the targeted school score, a red (less) or orange (equal) circle is displayed on the EA report respectively (see FIG. 2A). If the diagnostic report generated indicates that the targeted tier is beyond the student's current level, the system informs the student by setting the circle in red; if the EA score is close to the targeted tier score (within a threshold), the circle will be in orange color. The student can modify his/her targeted tier to a lower ranked tier, for example for tier 2 schools (US News ranked 17-28 schools), the GPA requirement is 3.75, A-G units is 52, Honor classes is 16 (see Table 2), if tier 2 is beyond the student's current level, he/she can switch to tier 3 schools.

All the tier factors and coefficient used for the diagnostic function are subject to change; they can vary from year to year, the data management system will update the tier factors and coefficient based on different schools and different admission data collected from the previous year.

The requirement for all Tiers schools are listed as Table 2 below:

TABLE 2

| Tier Factors | Tier 1 | Tier 2 | Tier 3 | Tier 4 | Tier 5 |
|---|---|---|---|---|---|
| GPA | 3.85 | 3.75 | 3.65 | 3.5 | <3.5 |
| A-G | 56 | 52 | 48 | 46 | <46 |
| Honor/AP | 20 | 16 | 12 | 8 | <8 |
| SAT | 2250 | 2100 | 1950 | 1800 | <1800 |
| SAT Subject (required 2) | 770/2 | 700/2 | 650/2 | 650/2 | |
| Club (1)** | 3 | 2 | 2 | 2 | |
| Sports (1)** | 2 | 1 | 1 | 1 | |
| Talents (1)** | 3 | 2 | 2 | 1 | |
| Leadership (3)** | 2 | 1 | 1 | 1 | |
| Education Prep (2)** | 2 | 2 | 2 | 1 | |
| Volunteer (2)** | 450 HR | 300 HR | 200 HR | 100 HR | |
| Work (1)** | 2 | 1 | 1 | 1 | |
| Signature Program (2)** | 2 | 1 | 1 | 1 | |

(N)** coefficient for each factor

(N)** coefficient for each factor
Target school: Tier 1 schools: GPA>=3.85; Tier 2 schools: GPA>=3.75;
Tier 3 schools: GPA>=3.65; Tier 4 schools: GPA>=3.5; Others GPA<3.5. The coefficient numbers listed above (by each of the EA event) are showing the importance of each of the factors, such as the Leadership is 3, that means it's more important than ‘signature program’, which is 2.

Another key function that is part of the data management system is the College Admission Optimizer, which provides the college admission chances prediction function. The College Admission Optimizer basically uses a logistic regression model, based on the admission history of college applications (ThinkTank Learning students), and student's current performance, and calculates the chances of admission for each of the selected schools, hence provides a strategic opinion. The College Admission Optimizer is executed automatically by the data management system. The College Admission Optimizer uses quantified factors, such as California A-G courses, Honor/AP classes, SAT Regular (SAT I) score, SAT Subject (SAT II) score, EA hours, UC-GPA, Trend (0-2), Awards (0-2), Leadership (0-2), and UN GPA (non-UC GPA for non-UC applications), see FIG. 6. Among these factors, values for Trend, Leadership, and Awards, please see Table 3 below:

TABLE 3

| | |
|---|---|
| Awards: | 0 if School wide competitions |
| | 1 if District wide (County, city) competitions |
| | 2 if State or National competitions |
| | If there are more than 3 awards in 0 category, it becomes 1 |
| | If there are more than 3 awards in 1 category, it becomes 2 |
| | If there are 2 awards in 0 category and 2 awards in 1 |
| | category, it is still 1 |
| Leadership: | 0 if 0 or 1 officership/leader in an organization |
| | 1 if 2 or 3 officerships/leaderships in DIFFERENT |
| | organizations |
| | 2 if 4 or more officerships/leaderships in DIFFERENT |
| | organizations |
| Trend: | 0 means GPA is trending down (lower and lower GPA) |
| | 1 means GPA is flat |
| | 2 if GPA is trending up |

The beauty of the admission chances prediction approach is it can remind the student that he/she should spend his/her time and effort in a field that he/she is still weak on.

The College Admission Optimizer is based on a multi-variable logistic regression model, and the formula looks as the following:

$${P}_{( admission \vert {X}_{1} , {X}_{2} , {X}_{3} , … {X}_{n} )} = \frac{{e}^{{a}_{0 +} {a}_{1} {X}_{1 + … +} {a}_{n} {X}_{n}}}{1 + {e}^{{a}_{0 +} {a}_{1} {X}_{1 + … +} {a}_{n} {X}_{n}}}$$

$$\begin{matrix}{School}_{1 =} ( {a}_{0}^{1} , {a}_{1}^{1} , {a}_{2}^{1} , … {a}_{n}^{1} ) \\ {School}_{2 =} ( {a}_{0}^{2} , {a}_{1}^{2} , {a}_{2}^{2} , … {a}_{n}^{2} ) \\ … \\ {School}_{n =} ( {a}_{0}^{n} , {a}_{1}^{n} , {a}_{2}^{n} , … {a}_{n}^{n} ) \\ {Student}_{1 =} ( {X}_{1}^{1} , {X}_{2}^{1} , … {X}_{n}^{1} ) \\ … \\ {Student}_{n =} ( {X}_{1}^{n} , {X}_{2}^{n} , … {X}_{n}^{n} )\end{matrix}$$

Wherein “P” is the probability; “a” are coefficients for each different schools;
and X are factors for each different students

The coefficients are updated each year with each year's admission data.

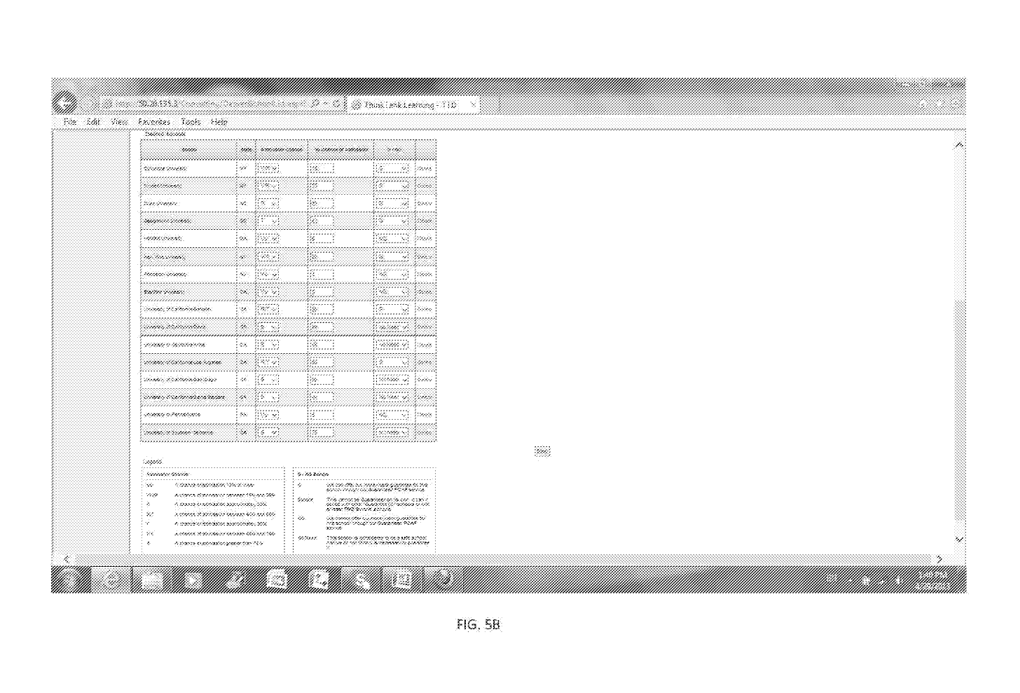

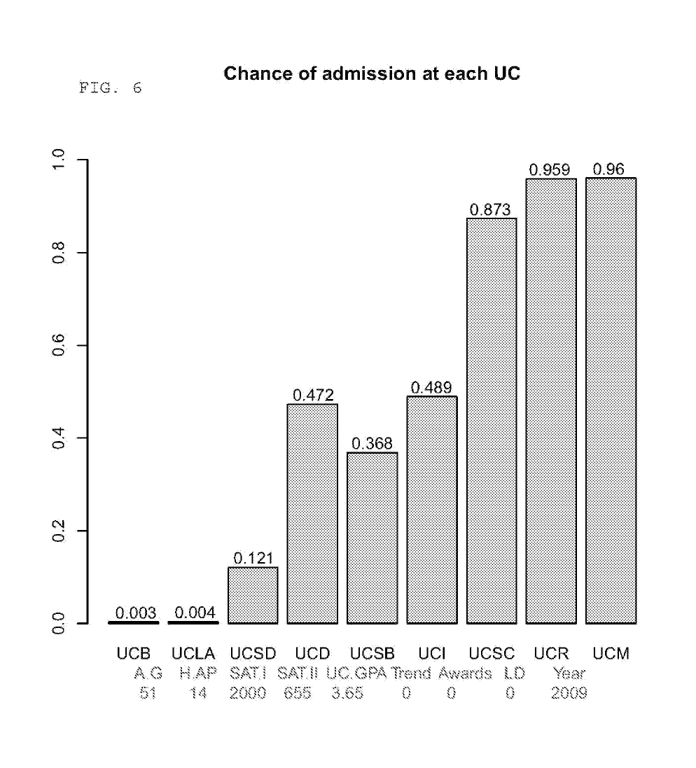

The result of the analysis for chances of admissions for each of the applied schools is also provided in ‘College List’ screen, see FIG. 5A and 5B; wherein, admission chances are calculated based on the above mentioned mathematic model automatically, and the results are divided into seven levels, they are: VU (a chance of admission is 15% or lower), VU/R (a chance of admission is between 15% to 35%), R (a chance of admission is approximately 35%), R/T (a chance of admission is between 40 to 55%), T (a chance of admission is approximately 60%), T/S (a chance of admission is between 65% to 75%), and S (a chance of admission is greater than 75%). The chance of admission is also used to decide what type of contract (an agreement between the student and the education consulting institute) the student should use. If the student has high chances to be admitted to his/her targeted schools, a Guaranteed Total Solution (GTS) contract can be used. This function is very helpful for marketing staff to use when determining the contract type. The statistic model that was generated from the historical admission data.

FIG. 6 indicates the optimizer originally calculated all UC admission chances for a student with 51 A-G courses, 14 AP/Honor courses, SAT II average score 655, SAT score 2000, UC-GPA 3.65, and Leadership (LD) 0;

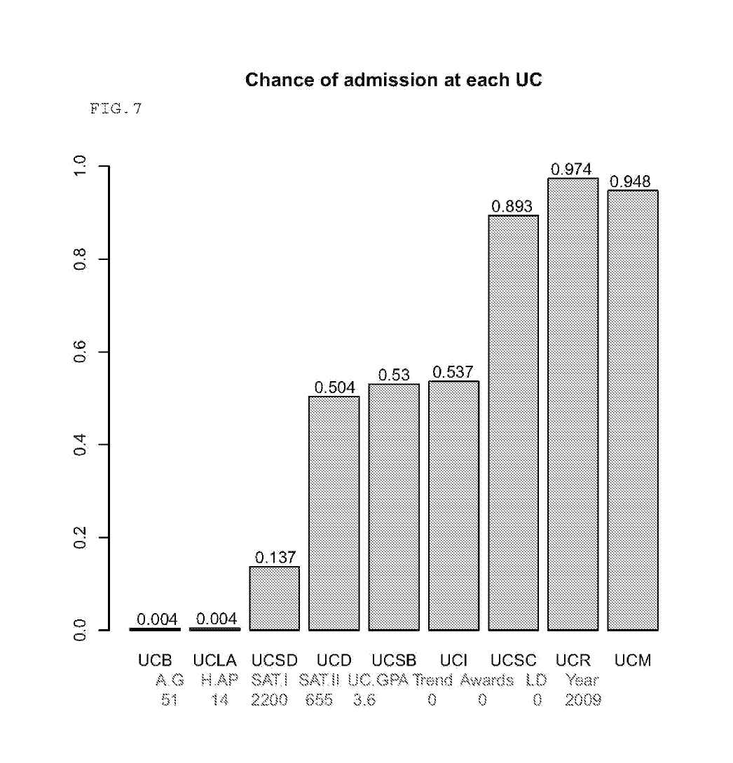

FIG. 7 indicate when all other factors remain the same, the SAT scores changed from 2000 to 2200, e.g. the UCSD admission chance has changed from 12% to 14%; UCSB admission chance has changed from 37% to 53%, etc.

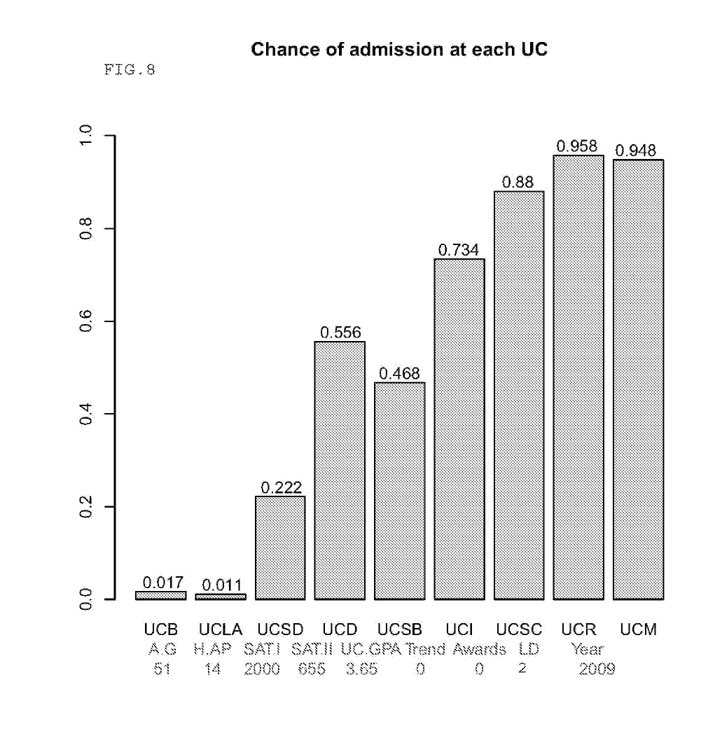

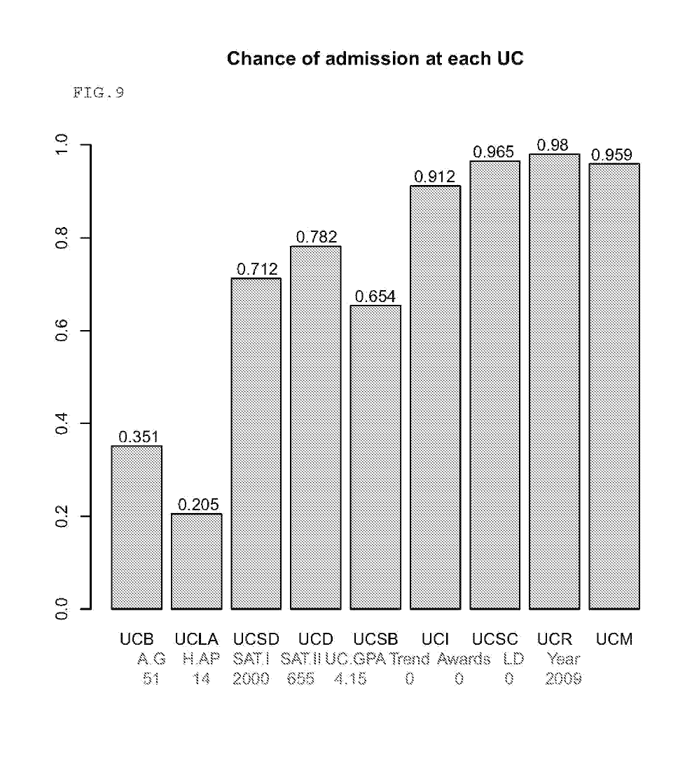

FIG. 8 indicate when all other factors remain the same, the Leadership factor has changed from 0 to 2, the UCSD admission chances raised from 12% to 22%, etc.

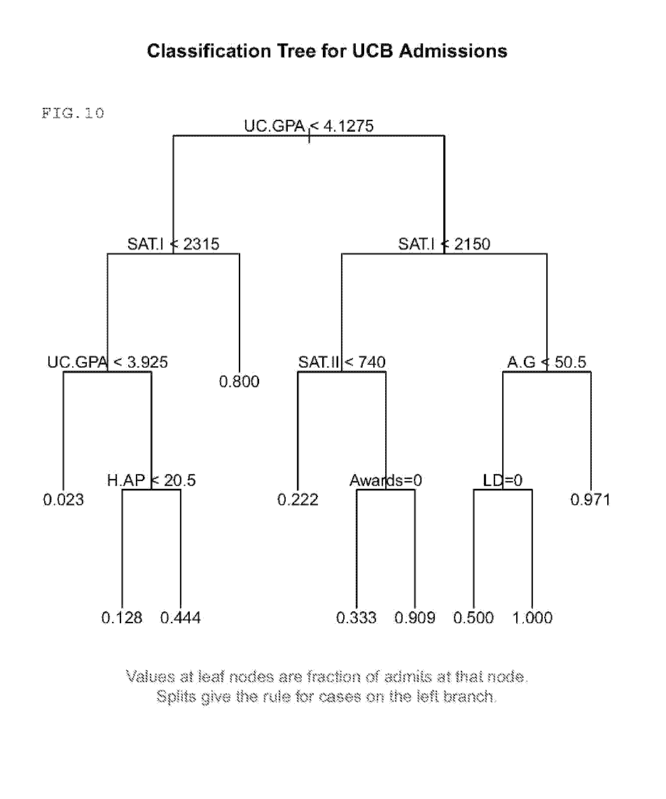

FIG. 9 indicates when all other factors remain the same, the UC-GPA made a significant difference to the admission chances; all schools' admission chances jumped high.—from FIGS. 6, 7, 8, and 9 we can tell bringing up GPA is definitely the most important thing if same amount of time can be given.

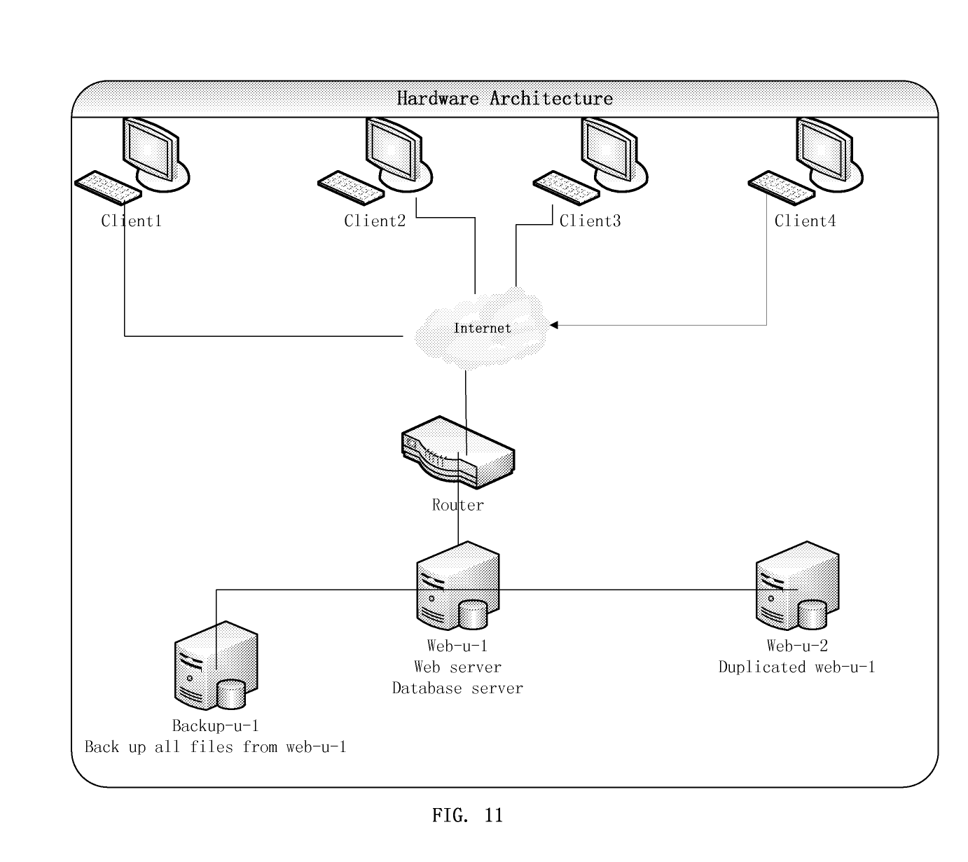

FIG. 10 shows a ‘admission tree’ for UC Berkeley produced by the College Admission Optimizer, it indicates the admission chances for the UC Berkeley, if a student's GPA>=4.125, and his/her SAT I score is>=2150, and he/she has more than 50 A-G courses taken, his acceptance chance is 97.1% (the right most node of the tree). This tree actually provides the break points for various admission criteria.

FIG. 11 is an exemplary hardware architecture of the present invention. Wherein Web-u-1 is the web and database server, the Web-u-2 is a backup web and database server designed for fault tolerance purpose, and the Backup-u-1 is used to backup all files from Web-u-1. The Web-u-1 and Web-u-2 and all the clients are connected via a network.

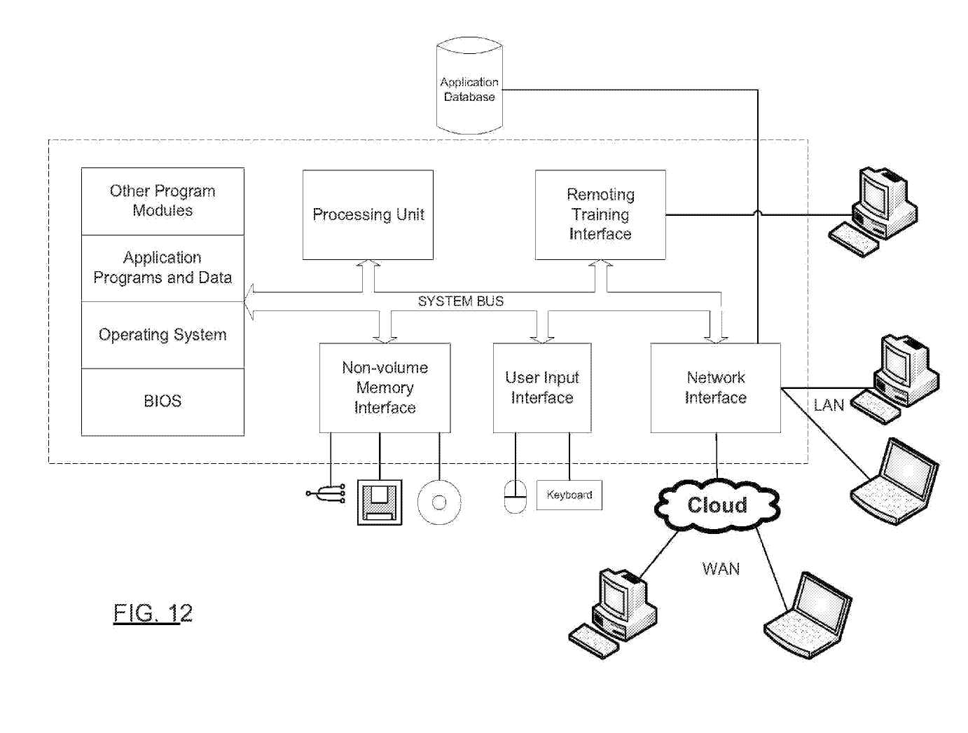

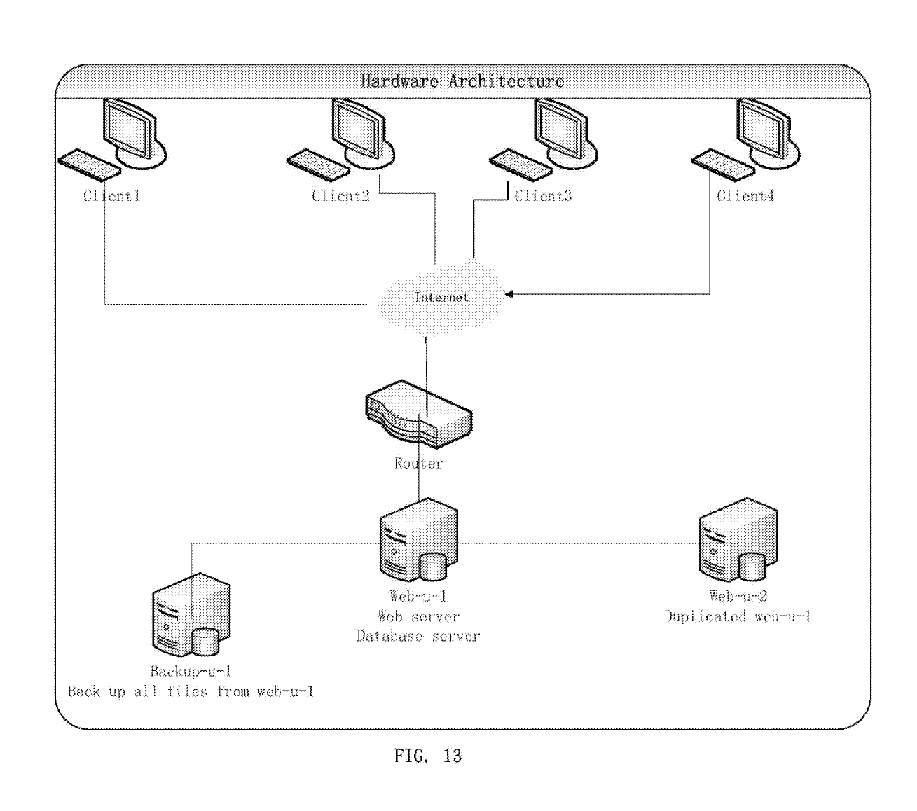

FIG. 12 is an exemplary of a computing system environment in which the invention may be implemented. The educational counseling system can be implemented in such a computing system or anything that is similar to this computing system.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures can be easily combined within the scope of the invention.

What is claimed is:

1. A computer-implemented method for an education consultant, operating a data management system, to assist a student to apply schools, comprising:
receiving, from an input device, student information, the student information being collected by the education consultant via an intake meeting with the student,
storing the student information in the data management system ;
generating, by a strategic calculation unit, a strategic positioning report for the student according to the stored student information;
storing the strategic positioning report in the data management system;
producing, by a document generation unit and using the strategic positioning report, a school application essay brainstorm document for the student,
the school application essay brainstorm document is retrievable from the data management system and the school application essay brainstorm document serves as a blueprint for the student's future college application essays;
selecting, by the strategic calculation unit, a school tier for the student;
receiving, from the input device, the academic data, extracurricular activities data, and standardized tests data for the student;
generating, by the data management system, a diagnostic report for the student based on the academic data, the extracurricular data, the standardized test data and the selected school tier;
selecting schools based on the diagnostic report for the student;
calculating chance of admission automatically, by the data management system for each of the selected schools; and
creating, by the data management system, a school application status based upon the selected schools.

2. The computer-implemented method of claim 1, wherein the step of calculating chance of admission further comprising:
using a logistic regression model to implement a College Admission Optimizer, the College Admission Optimizer calculates the chances of admission for each of the selected schools.

3. The computer-implemented method of claim 2, wherein the logistic regression model including coefficients for A-G course, Honor/AP courses, SAT regular test score, SAT subject score, Extracurricular Hours, UC GPA, Trend, Awards, Leadership, and Non-UC GPA.

4. The computer-implemented method of claim 2, wherein the step of using the logistic regression model further includes:
$${P}_{( admission \vert {X}_{1} , {X}_{2} , {X}_{3} , … {X}_{n} )} = \frac{{e}^{{a}_{0 +} {a}_{1} {X}_{1 + … +} {a}_{n} {X}_{n}}}{1 + {e}^{{a}_{0 +} {a}_{1} {X}_{1 + … +} {a}_{n} {X}_{n}}}$$
$$\begin{matrix}{School}_{1 =} ( {a}_{0}^{1} , {a}_{1}^{1} , {a}_{2}^{1} , … {a}_{n}^{1} ) \\ {School}_{2 =} ( {a}_{0}^{2} , {a}_{1}^{2} , {a}_{2}^{2} , … {a}_{n}^{2} ) \\ … \\ {School}_{n =} ( {a}_{0}^{n} , {a}_{1}^{n} , {a}_{2}^{n} , … {a}_{n}^{n} ) \\ {Student}_{1 =} ( {X}_{1}^{1} , {X}_{2}^{1} , … {X}_{n}^{1} ) \\ … \\ {Student}_{n =} ( {X}_{1}^{n} , {X}_{2}^{n} , … {X}_{n}^{n} )\end{matrix}$$
Wherein “P” is the probability; “a” are coefficients for each different schools;
and X are factors for each different students

5. A non-volatile computer storage media comprising computer executable instructions which, when executed by a computer system, cause the computer system to perform the steps of:
receiving student information from an input device, the student information being collected by an education consultant via an intake meeting with a student,
storing the student information in a data management system;
generating, by a strategic calculation unit, a strategic positioning report for the student according to the stored student information;
storing the strategic positioning report in the data management system;
producing, by a document generation unit and using the strategic positioning report, a school application essay brainstorm document for the student,
the school application essay brainstorm document is retrievable from the data management system and the school application essay brainstorm document serves as a blueprint for the student's future college application essays;
selecting, by the strategic calculation unit, a school tier for the student;
receiving, from the input device, the academic data, extracurricular activities data, and standardized tests data for the student;
generating, by the data management system, a diagnostic report for the student based on the academic data, the extracurricular data, the standardized test data and the selected school tier;
selecting schools based on the diagnostic report for the student;
calculating chance of admission automatically, by the data management system for each of the selected schools; and
creating, by the data management system, a school application status based upon the selected schools.

6. The computer storage media of claim 5, wherein the step of calculating chance of admission further comprising:
using a logistic regression model to implement a College Admission Optimizer, the College Admission Optimizer calculates the chances of admission for each of the selected schools.

7. The computer storage media of claim 6, wherein the logistic regression model including coefficients for A-G course, Honor/AP courses, SAT regular test score, SAT subject score, Extracurricular Hours, UC GPA, Trend, Awards, Leadership, and Non-UC GPA.

8. The computer storage media of claim 6, wherein the step of using the logistic regression model further includes:
$${P}_{( admission \vert {X}_{1} , {X}_{2} , {X}_{3} , … {X}_{n} )} = \frac{{e}^{{a}_{0 +} {a}_{1} {X}_{1 + … +} {a}_{n} {X}_{n}}}{1 + {e}^{{a}_{0 +} {a}_{1} {X}_{1 + … +} {a}_{n} {X}_{n}}}$$
$$\begin{matrix}{School}_{1 =} ( {a}_{0}^{1} , {a}_{1}^{1} , {a}_{2}^{1} , … {a}_{n}^{1} ) \\ {School}_{2 =} ( {a}_{0}^{2} , {a}_{1}^{2} , {a}_{2}^{2} , … {a}_{n}^{2} ) \\ … \\ {School}_{n =} ( {a}_{0}^{n} , {a}_{1}^{n} , {a}_{2}^{n} , … {a}_{n}^{n} ) \\ {Student}_{1 =} ( {X}_{1}^{1} , {X}_{2}^{1} , … {X}_{n}^{1} ) \\ … \\ {Student}_{n =} ( {X}_{1}^{n} , {X}_{2}^{n} , … {X}_{n}^{n} )\end{matrix}$$
Wherein “P” is the probability; “a” are coefficients for each different schools;
and X are factors for each different students.
